(19) United States
(12) Patent Application Publication
(10) Pub. No.: US 2011/0281785 A1
(43) Pub. Date: Nov. 17, 2011

(54) FABRIC ENHANCERS COMPRISING NANO-SIZED LAMELLAR VESICLE

(76) Inventors: Yonas Gizaw, Cincinnati, OH (US); Raul Victorino Nunes, Loveland, OH (US); Ke-ming Quan, West Chester, OH (US); Alessandro Corona, III, Mason, OH (US); Matthew Lawrence Lynch, Mariemont, OH (US); Alice Marie Ward, Middletown, OH (US); Marc Johan Declercq, Strombeek (BE)

(21) Appl. No.: 13/196,083

(22) Filed: Aug. 2, 2011

Related U.S. Application Data
(63) Continuation of application No. 11/890,814, filed on Aug. 8, 2007.
(60) Provisional application No. 60/836,269, filed on Aug. 8, 2006.

(51) Int. Cl. C11D 3/60; B32B 5/16

(52) U.S. Cl. 510/516; 510/515; 428/402

(57) ABSTRACT

A fabric enhancer comprising: at least one cationic softening compound, wherein said cationic softening compound comprises a plurality of lamellar vesicles, said lamellar vesicles having an average diameter from about 10 nm to about 170 nm, wherein said fabric enhancer is capable of forming phase stable mixtures with enhanced stability in the presence of at least one cationic polymer and processes for making the same.

### CROSS REFERENCE TO RELATED APPLICATIONS

This application is a continuation of and claims priority under 35 U.S.C. §120 to U.S. patent application Ser. No. 11/890,814, filed Aug. 8, 2007, which in turn claims the benefit under 35 U.S.C. §119(e) to U.S. Provisional Application No. 60/836,269, filed Aug. 8, 2006.

### BACKGROUND

Fabric enhancers comprising aqueous solutions containing cationic softening compounds such as quaternary ammonium compounds are known. These quaternary ammonium compounds tend to form lamellar sheets which can form lamellar vesicles, including uni-lamellar and multi-lamellar vesicles, typically having diameters greater than 200 nm. The presence of higher proportions of uni-lamellar vesicles is considered to produce desirable benefits such as good fabric softening. Efforts to increase the proportion of uni-lamellar vesicles to multi-lamellar vesicles include the addition of specific solvents which affect the quaternary ammonium compounds during vesicle formation. See e.g. U.S. Pat. Nos. 6,521,589 to Demeyere et al., 6,211,140 to Sivik et al., 5,747,443 to Wahl et al., and U.S. Publ. No. 2003/0060390 to Demeyere et al. One problem associated with the use of these solvent technologies is that this approach is often too expensive for commercial use.

An alternative approach to enhancing fabric feel and/or softening while also limiting viscosity has been to add polymers to fabric enhancers. See e.g. U.S. Pat. Nos. 7,315,451 to Corona et al, 6,492,322 to Cooper et al. One problem associated with the presence of polymers in fabric enhancers is physical instability of the mixtures, characterized by bulk phase separation and the formation of a vesicle-rich top layer and a polymer-rich bottom layer. See Asakura S, and Oosawa F., Interaction between Particles Suspended in Solutions of Macromolecules, in J. of Poly. Sci., 33, 183-92 (1958).

Although many attempts have been made to provide fabric enhancers with desirable benefits including good fabric softening, there remains a need for compositions comprising higher proportions of uni-lamellar vesicles without reliance on expensive solvents and which are capable of phase stability when in the presence of added polymers.

### SUMMARY OF THE INVENTION

The present invention is directed to a fabric enhancer comprising: at least one cationic softening compound, wherein said cationic softening compound comprises a plurality of lamellar vesicles, said lamellar vesicles having an average diameter from about 10 nm to about 170 nm.

Another aspect of the present invention is directed to a fabric enhancer comprising: at least one cationic softening compound, wherein said cationic softening compound forms a plurality of lamellar vesicles comprising a radius of lamellar vesicles from about 5 nm to about 85 nm; and at least one cationic polymer comprising a radius of gyration, wherein a ratio of said radius of lamellar vesicle to said radius of gyration of polymer (Rᵥ/R_{g}) is from about 40:1 to about 2:1

Yet another aspect of the present invention provides for a process of making a fabric enhancer comprising the steps of: providing a feed into a mixing chamber, said feed comprising: a cationic softening compound; and a solvent; subjecting said feed within said mixing chamber to an energy density from about 1 J/ml to about 50 J/ml thereby producing said fabric enhancer; and discharging said fabric enhancer from said mixing chamber at a flow rate from about 1 kg/min to about 1000 kg/min.

### DESCRIPTION OF THE DRAWINGS

FIG. 1 provides a Cryo-TEM micrograph comparison of a sample of nano-sized lamellar vesicles on the left and conventional fabric enhancer composition on the right.

FIG. 2 shows the relationship between the volume fraction of polymer versus volume fraction of vesicle by a phase diagram for a conventional fabric enhancer comprising lamellar vesicles with an average diameter of about 250 nm.

### DETAILED DESCRIPTION

It has surprisingly been found that fabric enhancers comprising a plurality of lamellar vesicles, comprising an average diameter from about 10 nm to about 170 nm, hereinafter “nano-sized lamellar vesicles” tend to form uni-lamellar vesicles. These fabric enhancers have been achieved by processing through high energy density technologies which use hydrodynamic and/or ultra-sonic cavitation to create sufficient disruption to create nano-sized lamellar vesicles. It has been found that these compositions comprising nano-sized lamellar vesicles form phase stable mixtures, as shown by phase stability in the presence of polymers, with good fabric enhancing capabilities, e.g. fabric feel and/or softening. Without intending to be bound by theory, it is believed that the nano-sized lamellar vesicles are sufficiently small in size such that the nano-vesicles tend to resist aggregating over time as compared to conventional fabric enhancers which tend to have particles which are non-nano-sized.

### I. NANO-SIZED LAMELLAR VESICLES

In one embodiment, the fabric enhancer comprises at least one cationic softening compound, wherein said at least one cationic softening compound forms a plurality of lamellar vesicles. In one embodiment, at least about 50% of said cationic softening compound forms lamellar vesicles, alternatively at least about 75%, alternatively at least about 90%, alternatively at least about 95%, to about 99%, alternatively to about 99.9%, by weight. Those of skill in the art will recognize that the cationic softening compound can further comprise discs, platelets, lamellar sheets, and mixtures thereof.

In one embodiment, the plurality of lamellar vesicles, the nano-sized lamellar vesicles, comprise an average diameter (or size) from about 10 nm, alternatively from about 30 nm, alternatively from about 50 nm, alternatively from about 60 nm, alternatively from about 80 nm, and to about 170 nm, alternatively to about 160 nm, alternatively to about 150 nm, alternatively to about 140 nm, alternatively to about 130 nm, as determined by Dynamic Light Scattering Method as defined herein. As used herein, average diameter includes average size.

In one embodiment, at least about 50% of said cationic softening compound, alternatively at least about 75%, alternatively at least about 90%, alternatively at least about 95%, alternatively at least about 98%, to about 99%, alternatively to about 99.9%, are nano-sized lamellar vesicles, in accordance with the Dynamic Light Scattering Method. Without intending to be bound by theory, it is believed that these nano-sized lamellar vesicles tend to be predominately uni-lamellar. In another embodiment, at least about 50% of the nano-sized lamellar vesicles, alternatively at least about 75%, alternatively at least about 90%, alternatively at least about 95%, alternatively at least about 98% to about 99%, alternatively to about 99.9%, are uni-lamellar, by weight.

As used herein, average diameter is in reference to the outer layer of the lamellar vesicles and is determined by the Dynamic Light Scattering Method as defined herein.

A. Dynamic Light Scattering Method:

The Dynamic Light Scattering Method measures the average diameter of the lamellar vesicles by light scattering data techniques, which is an intensity-weighted average diameter.

One suitable machine to determine the average diameter is a Brookhaven 90Plus Nanoparticle Size Analyzer. A dilute suspension with concentration ranging from 0.001% to 1% v/v using a suitable wetting and/or dispersing agents is prepared. A 10 mL sample of the suspension is placed into a sample cell and measurements are recorded providing average particle diameter.

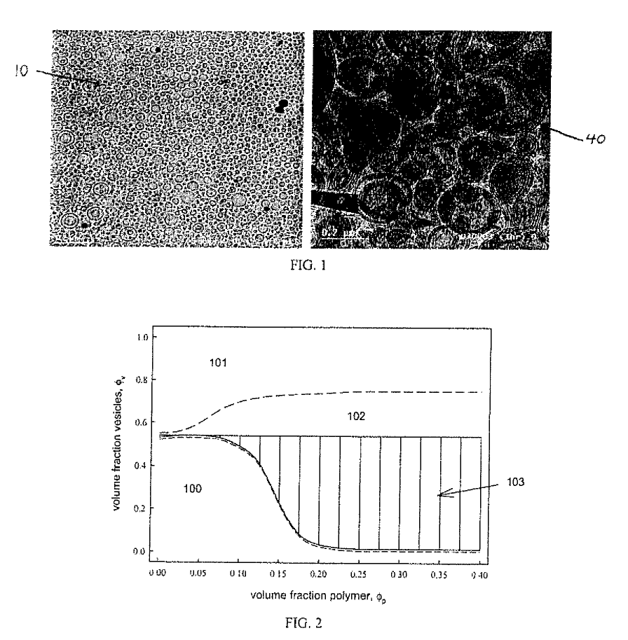

FIG. 1 provides a microscopic view of a sample of nano-sized lamellar vesicles on the left and conventional fabric enhancer composition on the right. As shown by FIG. 1, the nano-sized lamellar vesicle sample to the left comprises a high proportion of nano-sized lamellar vesicles (10) having average diameter of from about 10 nm to about 170 nm, whereas the conventional sample to the right comprises a plurality of non-nano sized lamellar vesicles (40) which are multi-lamellar with diameters greater than about 200 nm.

Without wishing to be bound by theory, it is believed that compositions comprising these nano-sized lamellar vesicles provide one or more of the following benefits: enhanced stability, flocculation inhibition, good fabric feel and/or softness. Further, it is believed that lamellar vesicles having a nano-sized diameter of the present invention tend to form uni-lamellar vesicles due to the chemical and physical properties of the cationic softening compositions.

### II. FABRIC ENHANCER COMPOSITION COMPONENTS

A. Cationic Softening Compound

The fabric enhancers of the present invention comprise a cationic softening compound or a mixture of more than one cationic softening compound. In one embodiment, the fabric enhancer comprises from about 1%, alternatively from about 2%, alternatively from about 3%, alternatively from about 5%, alternatively from about 10%, and alternatively from about 12%, to about 90%, alternatively to about 40%, alternatively to about 30%, alternatively to about 20%, alternatively to about 18%, alternatively to about 15%, of said cationic softening compound, by weight of the composition.

In one embodiment, the cationic softening compound comprises a quaternary ammonium compound. In one embodiment, the quaternary ammonium compound includes an ester quaternary ammonium compound, an alkyl quaternary ammonium compound, or mixtures thereof. In yet another embodiment, the ester quaternary ammonium compound includes a mixture of mono- and di-ester quaternary ammonium compound. Those skilled in the art will recognize that cationic softening compounds can be selected from mono-, di-, and tri-esters, as well as other cationic softening compounds, and mixtures thereof, depending on the process and the starting materials. Further, those skilled in the art will recognize that cationic softening compounds can be selected from tertiary ammonium compounds, as well as other cationic softening compounds, and mixtures thereof. Suitable fabric softening compounds are disclosed in U.S. Pat. Pub. No. 2004/0204337. Suitable di-ester quaternary ammonium compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., tallow, hardened tallow, oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, palm oil, etc.

In one embodiment, the fabric enhancer comprises a quaternary ammonium composition having from about 0.1% to about 30% of mono-ester quaternary ammonium, alternatively from about 0.5% to about 20% of mono-ester quaternary ammonium, by weight of fabric enhancer, alternatively from about 2% to about 12% of mono-ester quaternary ammonium, by weight of fabric enhancer.

Iodine Value

In one embodiment, the cationic softening compounds are made with fatty acid precursors with a range of Iodine Values (herein referred to as “IV”) from about zero to about 140. As defined here, Iodine Value is the number of grams of iodine absorbed per 100 grams of the sample material. One aspect of the invention provides for, but is not limited to, performance characteristics that include fabric softening and/or static performance based upon IV ranges. For example, in one embodiment the compositions of the present invention comprises an IV range of from about 40 to about 140; alternatively from about 35 to about 65, alternatively from about 40 to about 60; alternatively from about 1 to about 60, alternatively from about 15 to about 30, alternatively from about 15 to about 25.

Further, while it is acceptable to use cationic softening compounds a transition temperature from about −50° C. to about 100° C.; in one embodiment provides for a fabric softening compound with a transition temperature of equal to or less than about 50° C.

B. Cationic Polymers

In one embodiment, the fabric enhancer further comprises at least one cationic polymer, alternatively a mixture of two or more cationic polymers. In another embodiment, the fabric enhancer comprises from about 0.01% to about 5%, alternatively from about 0.03% to about 3%, alternatively from about 0.1% to about 1% of said cationic polymer by weight of said fabric enhancer composition. In yet another embodiment, the weight ratio of cationic softening compound:cationic polymer is in a range from about 2:1, alternatively about 3:1, alternatively about 4:1, alternatively about 5:1, and alternatively about 6:1 to about 500:1, alternatively about 50:1, alternatively about 40:1, and alternatively about 30:1.

The cationic polymer has a charge density of from about 0.01 meq/mg to about 24 meq/mg, alternatively from about 0.1 meq/mg to about 8 meq/mg, alternatively from about 0.5 meq/mg to about 7 meq/mg, alternatively from about 2 meq/mg to about 6 meq/mg. Non-limiting examples of suitable cationic polymers are disclosed in U.S. Pat. No. 6,492,322, col. 6, line 65—col. 24, line 25.

One embodiment, the cationic polymer is a flocculating polymer. In another embodiment, the cationic polymer is free or substantially free of a deflocculating polymer.

In one embodiment, the cationic polymer is water soluble, for instance to the extent of at least about 0.5% by weight of the cationic polymer is water soluble at 20° C. In another embodiment, the cationic polymers may have molecular weights (in Daltons) of from about 25,000 to about 5,000,000, alternatively from about 100,000 to about 1,500,000, alternatively from about 300,000 to about 1,000,000.

In one embodiment of the present invention, the cationic polymer is generally non-covalently attached to the fabric softening compound. In another embodiment, the cationic polymer is generally non-covalently attached to the lamellar vesicles. As used herein, generally non-covalently attached means less than about 50% of said polymer is covalently attached, alternatively less than about 25%, alternatively less than about 10%, alternatively less than about 5%, alternatively less than about 1%, alternatively less than about 0.05%, alternatively less than about 0.01% by weight of said polymer. Those of ordinary skill in the art will recognize that centrifugation can be used to determine whether a cationic polymer covalently attaches. The presence of covalent attachments can be determined by centrifuging a sample of the composition; if the cationic polymer forms a separate material from the fabric softening compound, then the cationic polymer is not covalently attaching. Additionally, the composition can be analyzed for covalent bonding using Ionization techniques including but not limited to: Matrix Assisted Laser Desorption Ionization; Electrospray Ionization; and Fourier transform ion cyclotron resonance mass spectrometry (FT-ICR-MS).

i. Cationic Starch

In one embodiment of the present invention, the cationic polymer comprises cationic starch. In one embodiment, the cationic starch of the present invention comprises amylose at a level of from about 0% to about 70% by weight of the cationic starch. In another embodiment, when the cationic starch comprises cationic maize starch, said cationic starch comprises from about 25% to about 30% amylose, by weight of the cationic starch. The remaining polymer in the above embodiments comprises amylopectin. Suitable cationic starches for use herein are disclosed in U.S. Pat. No. 7,135,451, col. 2, line 33—col. 4, line 67.

ii. Additional Suitable Cationic Polymers

The cationic polymers of the present invention can be amine salts or quaternary ammonium salts. Additionally, the cationic polymer comprises a natural polymer, a synthetic polymer, a derivative of a natural polymer, a derivative of a synthetic polymer, and a mixture thereof. Suitable mixtures of polymers include two or more polymers which are phase compatible, such as: linear polymers, such as amylose; branched polymer, such as amylopectin; and combinations of linear and branched polymers.

C. Other Elements

i. Perfume Additive

In one embodiment, the fabric enhancer comprises a perfume additive. As used herein “perfume additive” means any odoriferous material that is subsequently released into the aqueous bath and/or onto fabrics contacted therewith. The perfume additives herein can be relatively simple in their compositions or can comprise highly sophisticated complex mixtures of natural and synthetic chemical components, all chosen to provide any desired odor. Nonlimiting examples of different perfume compositions are available in U.S. Pat. Publ. No. 2003/0104969A1 issued Jun. 5, 2003 to Caswell et al.; U.S. Pat. No. 5,714,137 issued Feb. 3, 1998 to Trinh et al.; and U.S. Pat. No. 6,048,830 issued Apr. 11, 2000 to Gallon et al.

In one embodiment, the perfume additive comprises a perfume microcapsule. Perfume microcapsules may include those described in the following references: U.S. Pat. Publ. Nos. 2003/215417 A1, 2003/216488 A1, 2003/158344 A1, 2003/165692 A1, 2004/071742 A1, 2004/071746 A1, 2004/072719 A1, 2004/072720 A1, 2003/203829 A1, 2003/195133 A1, 2004/087477 A1, 2004/0106536 A1; EP 1393706 A1; U.S. Pat. Nos. 6,645,479, 6,200,949, 4,882,220, 4,917,920, 4,514,461, 4,234,627 and U.S. RE 32,713. In one embodiment, the perfume microcapsule is a friable perfume microcapsule (versus, e.g., a water-activated perfume microcapsule). Friability refers to the propensity of the microcapsules to rupture or break open when subjected to direct external pressures or shear forces. For purposes of the present invention, the microcapsules utilized are “friable” if, while attached to fabrics treated therewith, they can be ruptured by the forces encountered when the capsule-containing fabrics are manipulated by being worn or handled (thereby releasing the contents of the capsule).

ii. Aqueous Carrier

The present compositions will generally comprise an aqueous carrier comprising water. The level of aqueous carrier generally constitutes the balance of the present compositions, comprising from about 10% to about 95%, alternatively from about 20% to about 80%, alternatively from about 30% to about 70%, and alternatively from about 40% to about 60%, of said aqueous carrier by weight of said fabric enhancer.

iii. Additional Additives

Those of ordinary skill in the art will recognize that additional additives are optional but are often used in fabric enhancers. The fabric enhancer further comprises an additional additive comprising: colorants, perfumes, blooming perfumes, perfume microcapsules, cyclodextrin, odor controls, malodor, sud suppressors, electrolytes, preservatives, optical brighteners, opacifiers, structurants, viscosity modifiers, deposition aids, fabric conditioning agents in solid form such as clay, emulsifiers, stabilizers, shrinkage controllers, spotting agents, germicides, fungicides, anti-corrosion agents, pH modifiers, and mixture thereof, etc. See e.g. U.S. Pat. Nos. 4,157,307 to Jaeger et al., 5,942,217 to Woo et al., and 6,875,735 to Frankenbach et al. Additional suitable additives are known and can be included in the present formulation as needed. See e.g. U.S. Pat. Publ. No. 2004/0204337. In one embodiment, the fabric enhancer is free or substantially free of any of the aforementioned additives. As used herein, substantially free of a component means that no amount of that component is deliberately incorporated into the composition.

In one embodiment, the compositions of the present invention are free or substantially free of detersive surfactants. In one embodiment, the composition comprises from about 0% to about 5% of a detersive surfactant, alternatively to about 2%, alternatively to about 1%, alternatively to about 0.5%, by weight of the composition.

In another embodiment, the fabric enhancers of the present invention are free or substantially free of biological active (cosmetic or pharmaceutical) agents which are suited towards treating the symptoms and/or disorders living organisms, notably of the skin and hair. Further, in one embodiment, the composition is free of materials which are oxygen sensitive (e.g. agents such as retinol). U.S. Pat. Publ. Nos. 2002/0001613 at ¶¶ 45-48, and 2001/0124033, at paragraphs 42-43, provide examples of “biological active” agents which are notably absent in this embodiment of the present invention.

### III. COMPOSITION STABILITY GAINS

It has surprisingly been found that a fabric enhancer composition comprising the cationic softening compound as disclosed herein is capable of enhanced stability. Further, this enhanced stability can be observed by the presence of substantially no phase separation in the presence of added polymer.

A. Phase Stable Mixture

A phase stable mixture as defined herein, is a mixture which comprises substantially no phase separation as measured by the Shelf Storage Test, defined herein. As defined herein, substantially no phase separation means no greater than about 10% phase separation at any time during the Shelf Storage Test; alternatively no greater than about 5% phase separation, alternatively no greater than about 2% phase separation by volume of the sample. As used herein, phase separation and or phase split is determined according to the Shelf Storage Test as defined herein and means the formation of a vesicle rich upper layer and a polymer rich lower layer as visually observed or a turbidity reading device. As used herein, creaming is shown by the formation of distinct accumulations of vesicle rich globs or masses within the composition which tend to float towards the top.

Shelf Storage Test: Product is stored in a plastic container with lid for 4 weeks at temperatures of 40° F., 70° F., and 100° F. This test can be run using containers of between about 6 to about 10 oz in size. At the 1, 2 and 4 week intervals, phase stability is assessed by visual observation any phase split. If the sample has separated into visual layers at any time during the period of testing (total of 4 weeks), these are measured for height, and computed as a percent of the total sample height. The % phase split is calculated as a volume % from the visual measurement of the total sample height at the start of the test and at test intervals. No phase split means no top phase is observed.

The viscosity of the fabric enhancer can also be monitored during this test by using a Brookfield LVF viscometer, 60 rpm, #2 spindle. It has been found that the present invention does not show viscosity increase beyond 1000 centipoise.

Those of ordinary skill in the art will understand that phase unstable fabric conditioners typical exhibit the separation of a vesicle-rich phase (top) and polymer rich-phase (bottom). The phase separation usually begins within the first week, depending on the formulation and process. First, a top phase appears as a creamy layer believed to be due to the turbidity associated with the aggregating vesicles. Second, distinct layers are observed with a distinct discontinuity separating the phases. Typically the top phase is more turbid and is believed to be vesicle-rich. The bottom phase can be less turbid based on formulation and process used to form the composition. It has surprisingly been found that fabric enhancer compositions comprising nano-sized lamellar vesicle formulations show uniform texture throughout the sample for the four week duration of the Storage Stability Test. A typical stability test is to observe the sample at ambient conditions for about one week to observe creaming followed by phase separation in several weeks. Samples that demonstrate substantially no phase separation are stable and samples that fail to demonstrate substantially no phase separation are considered unstable.

B. Relationship of Vesicle to Polymer

Without being bound by theory, it has been observed that the addition of significant levels of polymers to fabric conditioners often leads to instabilities. This has been evidenced by phase separation of a vesicle-rich top phase and a polymer-rich bottom phase. Empirical evidence reveals dependence on both the cationic surfactant vesicle size and concentration and on polymer size and concentration.

One embodiment of the present invention provides for a fabric enhancer comprising: at least one cationic softening compound, wherein said cationic softening compound forms a plurality of lamellar vesicles comprising a radius of lamellar vesicles from about 5 nm to about 85 nm (wherein radius of said plurality of lamellar vesicles=½ average diameter of said plurality of said lamellar vesicles); and at least one cationic polymer comprising a radius of gyration, wherein a ratio of said radius of lamellar vesicle to said radius of gyration of polymer (Rᵥ/R_{g}) is from about 40:1 to about 2:1, alternatively from about 20:1 to about 5:1, and alternatively about 10:1. Rᵥ is ½ of the average diameter. Polymer R_{g} is calculated as follows:
R_{g} for high molecular weight polymers (MW>10⁵ Daltons) is determined by static light scattering measurements from polymer solutions prepared at different polymer concentrations made at different angles using the Zimm Analysis, as described in Zimm, J. Chem. Phys. 16, 1099, 1948 and Benoit, J. Phys. Chem. 58, 635, 1954.
R_{g} for low molecular weight polymers (M<10⁵ Daltons) is determined by dynamic light scattering measurements from polymer solutions prepared a polymer solution at ˜1% w/w at a fixed scattering angle, as described in Dynamic Light Scattering, Application of Photon Correlation Spectroscopy (R. Pecora ed., Plenum Press 1985).

The specific compositions, processes and properties of the polymer that result in phase separation are very intricate and therefore challenging to be able to control. Those of skill in the art will recognize deciphering composition stability in the presence of polymer requires consideration of polymer concentration, polymer size and molecular weight, as well as relative concentration of the lamellar vesicles. It is believed that to unify all these variables, the behavior of the mixture can be re-scaled in terms of volume fractions of vesicles and polymer. For example, a given cationic surfactant, lamellar vesicle size, and concentration (translated into a specific vesicle volume fraction), low amounts of polymer (extrapolated into polymer volume fraction) may show no instability, whereas an increase in polymer volume fraction may cause phase split.

Phase diagrams are commonly used by those of ordinary skill in the art to provide insight into inter-relationship between composition mixtures. Phase diagrams are often drawn with the volume fraction of vesicles along y-axis and the volume fraction of polymer along the x-axis with dotted lines separating the phase regions.

FIG. 2 shows the phase behavior of a fabric enhancer composition comprising lamellar vesicles with an average diameter is about 250 nm and polymer comprising R_{g} less than about 12.5 nm. Those of skill will recognize that phase diagrams for fabric enhancer compositions comprising lamellar vesicles with differing average diameter and polymers with differing R_{g} will provide different phase behavior. FIG. 2 is used herein to illustrate the phase behavior of convention of fabric enhancers as compared to the present invention.

As shown in FIG. 2, Region 100 corresponds to a stable formulation region, with no phase separation (below lower dashed line). This is the case for low concentrations of polymer (on the order of 0.1-0.2 v/v which is˜0.1-0.2% w/w). Region 101 of FIG. 2 corresponds to compact formulation region with dense-packed vesicles (above the dashed line). Region 101 pertains primarily to the situation where the vesicles are dense-packed in the mixture, become more packed with further increases in polymer concentrations. Region 102 of FIG. 2 corresponds to phase split regions (between the dashed lines) in which the sample splits into two phases: one vesicle-rich phase and one polymer-rich phase. Region 103 corresponds to the formulation region (vertical straight lines) addressed primarily in the present invention. Region 103 of FIG. 2 is illustrative of fabric enhancers which, under conventional formulations and processing, are unstable with phase separation as determined by the Shelf Storage Test described herein. It has surprisingly been found that fabric enhancers comprising nano-sized lamellar vesicles are capable of enhanced stability into the region of Region 103.

In one embodiment, the cationic softening compound further comprises a volume fraction of vesicles from about 0.01, alternatively, 0.05 to about 0.60, alternatively less than about 0.55. Without intending to be bound by theory, it is believed that fabric enhancer compositions comprising nano-sized lamellar vesicles of the present invention are capable of enhanced phase stability in the presence of increased volume fraction of polymer as compared to fabric enhancer compositions comprising non-nano-sized lamellar vesicles compounds, e.g. providing phase stability from about 0.00 volume fraction of polymer to about 0.40 volume fraction of polymer.

### I. DETERMINATION OF THE VOLUME FRACTION OF POLYMER

The volume fraction of the polymer can be calculated by Equation 1:

$${φ}_{p} = \frac{v}{V} \approx \frac{4}{3} π {R}_{g}^{3} ( \frac{n}{V} ) \approx \frac{4}{3} π {R}_{g}^{3} \frac{1}{V} \frac{{WN}_{a}}{{M}_{p}} \qquad Equation 1$$

where:

| | |
|---|---|
| V | volume of the polymer |
| V | total volume of the sample |
| R_{g} | radius of gyration of the polymer |
| N | number of polymer molecules |
| W | mass of polymer |
| Nₐ | Avogadro's number = 6.02 × 10²³ molecules/mole |
| Mₚ | molecular weight of the polymer |
| Rᵥ | radius of lamellar vesicles |

### II. DETERMINATION OF THE VOLUME FRACTION OF THE LAMELLAR VESICLES

First, calculate the mass of a vesicle:

Mᵥ≈4πr²tρ Equation 2

Then, calculate the number of vesicles per 100 ml of solution:

$$N = \frac{{C}_{V}}{{M}_{I}} \qquad Equation 3$$

Finally, the volume fraction of vesicles is computed by:

$${φ}_{v} = \frac{4 N π {R}_{v}^{3}}{300} \qquad Equation 4$$

Where, the typical values of the variables are:

| | |
|---|---|
| P | density of the cationic softener compound, e.g. 0.9 g/cm³ |
| T | bilayer thickness, e.g. 50 Å (measured by small angel X-ray |
| | scattering) |
| Mₗ | molecular weight of the cationic softener compound, e.g. 665 g/mole |
| Cᵥ | concentration of vesicles in w/w% |

### IV. PROCESSES OF MANUFACTURE

It has surprisingly been found that the compositions of the present invention can be manufactured using a process which involves cavitation within the composition generated by an ultra-sonic homogenizer. As used herein, ultra-sonic homogenizers include hydrodynamic cavitation reactors. Without intending to be bound by theory, it is believed that the hydrodynamic or ultrasonic cavitation causes sufficient disruption within the composition to create suitably sized lamellar vesicles.

The process for manufacturing the present compositions comprises: providing a feed into a mixing chamber, where the feed contains at least a cationic softening compound and a solvent such as an aqueous carrier; then exerting an energy density onto said feed from about 1 J/ml to about 50 J/ml to cause intense cavitation within the feed within the mixing chamber to thereby produce a fabric enhancer. This process then includes the step of discharging the fabric enhancer at a flow rate from about 1 kg/min to about 1000 kg/min. In one embodiment, the feed is fed into said mixing chamber via an element forming an orifice. In one embodiment, the mixing chamber comprises a blade.

It is believed that the process step of subjecting the feed to an energy density onto said feed from about 1 J/ml to about 50 J/ml causes cavitation within the composition traveling within the mixing chamber causes sufficient disruption to the feed within the mixing chamber to cause the cationic softening compound to form nano-sized lamellar vesicles according to the present invention.

In one embodiment, the feed further comprises a cationic polymer, a perfume, an additional additive as defined above, and mixtures thereof. In yet another embodiment, the discharged fabric enhancer composition is further mixed with additional additives comprising: a perfume, a perfume microcapsule, an additional additive as defined above, and mixtures thereof.

In another embodiment, the feed is introduced into the mixing chamber using a single feed, where the feed can be premixed and combined with water prior to introduction into the mixing chamber. In another embodiment, the feed is not pre-mixed before entering the mixing chamber. In a further embodiment, the feed is introduced into the mixing chamber using a dual feed with a first feed comprising and actives comprising said at least one cationic softening compound, said cationic polymer compound, said perfume additive, said other elements, and mixtures thereof, and a second feed comprising water. In one embodiment one or more of the feeds are premixed.

A. Energy Density

Energy Density is generated by exerting a power density on the feed within the mixing chamber for a residence time. In one embodiment of the present invention, the step of cavitating said feed in said mixing chamber is performed having an energy density from about 1 J/ml to about 100 J/ml, alternatively from about 1 J/ml to about 50 J/ml, alternatively from about 5 J/ml to about 35 J/ml. Energy Density can be represented by the equation:

E=W*ΔT

Where E represents energy density, W represents power density, and ΔT represents residence time. As defined herein, residence time means the average amount of time a vesicle remains within the mixing chamber. Residence time is determined by calculating the cavity size divided by the flow rate of fabric enhancer out of the mixing chamber.

B. Power Density and Residence Time

The fabric softener compositions of the present invention require relatively higher power density than conventional high sheer mixing. For ultrasonic mixing or a hydrodynamic cavitation reactor as used herein, power density can be determined by:

W=ΔP/ΔT

where W is the Power Density, ΔP is the applied pressure within the mixing chamber, and ΔT is the residence time.

In one embodiment, the energy density is generated from a power density of from about 0.5 W/ml to about 100,000 W/ml, alternatively from about 50 W/ml to about 30,000 W/ml. It is observed that the minimum Power Density required to achieve the fabric enhancer of the present invention is about 0.5 W/ml at 20 kHz.

Where the power density is about 0.5 W/ml, the residence time is about 15 minutes; alternatively, where the power density is about 100,000 W/ml the residence time is about 5 milliseconds. In one embodiment, the residence time is from about 1 millisecond (ms) to about 1 second, alternatively from about 1 ms to about 100 ms, alternatively from about 5 ms to about 50 ms. Further, where the residence time is less than 1 minute, the power density needs to be greater than 10 W/ml. Where the residence time is less than 1 second, the power density needs to be greater than 500 W/ml; alternatively. Where the residence time is less than 10 ms, the power density needs to be greater than 50,000 W/ml.

After the feed is subjected to the requisite energy density (as generated from the above mentioned power density and residence time), the fabric enhancer is discharged at a flow rate from about 1 kg/min to about 1000 kg/min, alternatively 10 kg/min to about 500 kg/min. Flow rate can be represented by the equation Q=30 A √(ΔP), where Q=flow rate, A=orifice size, and ΔP=pressure within the mixing chamber. As defined herein, orifice size is the orifice cross sectional area. In one embodiment, the orifice size is from about 0.0001 inches² to 0.1 about inches², alternatively 0.0005 inches² to 0.1 about inches².

C. Ultra-Sonic Mixing

In one embodiment, the device used to manufacture the fabric enhancer of the present invention is an ultrasonic homogenizer. Without intending to be bound by theory, it is believed that ultrasonic homogenizers achieve particle size reduction by hydrodynamic and/or ultrasonic cavitation. Further, it is believed that ultrasonic homogenizers are capable of operating at higher power and energy densities compared to conventional high shear mixers. See e.g. U.S. Pat. Publ. Nos. 2002/0001613 A1 to Neimiec et al., and 2004/0014632 A1 to Howard et al., and U.S. Pat. No. 5,174,930 to Stainmesse et al. One non-limiting example of a suitable ultrasonic homogenizer is the Sonolator™, supplied by Sonic Corporation of Connecticut.

The ultra-sonic homogenizer comprises a vibrating member which is capable vibrating in a wide in frequency range (e.g. from about 0.2 kHz to about 500 kHz). The frequency range for process according to the present invention ranges from about 10 kHz, alternatively from about 20 kHz to about 250 kHz, alternatively to about 50 kHz.

Using an ultra-sonic homogenizer, the power density is estimated by the pressure drop and the residence time over which the pressure releases. The energy density required to convert the feed into the fabric enhancer of the present invention is reached by controlling pressure applied to the feed.

In one embodiment, the ultra-sonic homogenizer comprises: a mixing chamber, said mixing chamber comprising an entrance, at least one inlet, and an outlet; and an element with an orifice therein, said element being located adjacent the entrance of said mixing chamber, wherein said element comprises portions surrounding said orifice, and at least some of said portions surrounding said orifice have a hardness of greater than that of cemented tungsten carbide, e.g. a Vickers hardness that is between about 20 and about 100 GPa. In another embodiment, the apparatus comprises a blade in said mixing chamber disposed opposite the element with an orifice therein, said blade having a leading edge, wherein the leading edge of said blade has a hardness of greater than that of cemented tungsten carbide, e.g. a Vickers hardness that is between about 20 and about 100 GPa. In yet another embodiment, said leading edge of said blade comprises: silicon nitride, titanium nitride, aluminum oxide, silicon carbide, titanium carbide, boron carbide, titanium diboride, boron oxide, rhenium diboride, cubic boron nitride, cubic BC2N, diamond-like carbon, diamond, composites of diamond and cubic boron nitride, and coatings of any of these materials, including diamond-coated materials and diamond-like carbon, and mixtures thereof. See U.S. Ser. No. 60/937,501, filed Jun. 28, 2007.

### V. EXAMPLES

### A. Example 1

First, two stock solutions of cationic softening compound are prepared. SAMPLES 1A & 1B: Nano-sized lamellar vesicle solution: 7.53 g of soft tallow diethyl ester dimethyl ammonium chloride is mixed with 100 ml of water. The mixture is then processed for 20 minutes with a Misonix© Sonicator 3000 tip, ultra-sonic homogenizer at 90 Watts. SAMPLES 1C & 1D: conventional fabric softener solution: fabric conditioner product at 21 wt % Di-tail ester of quaternary ammonium compound (surfactant).

Second, each sample is mixed with solutions of cationic polymer. Cationic polymer solution: 0.457 g of cationic starch polymer (0.49 wt % nitrogen and 500 kDa) is added to 30.0 ml of water added. This solution is then be heated to 80° C. for 30 min and cooled to room temperature.

Third, The Shelf Storage Test is then conducted.

TABLE 1
Composition of Samples

| | | Aver- | | | Volume | Volume | |
|---|---|---|---|---|---|---|---|
| | | age | | | Frac- | Frac- | |
| | | Vesi- | | | tion | tion | |
| | Vesicle | cle | | Polymer | Vesi- | Poly- | |
| Sam- | Solution | Dia- | | Solution | cle | mer | Phase |
| ple | Volume | meter | Water | Volume | ~Φv | ~Φp | Split? |
| 1A | 5.000 ml | 80 nm | 0.000 ml | 5.000 ml | 0.112 | 0.75 | No split |
| 1B | 5.000 ml | 80 nm | 2.855 ml | 3.000 ml | 0.112 | 0.45 | No split |
| 1C | 2.145 ml | 250 nm | 2.000 ml | 5.000 ml | 0.112 | 0.75 | Split |
| 1D | 2.145 ml | 250 nm | 4.855 ml | 3.000 ml | 0.112 | 0.45 | Split |

### B. Example 2

A solution with 14% quaternary ammonium compound and acidic water (without salt/electrolyte) is fed via dual feeds into a Sonolator® ultra-sonic mixer. Both feed streams are pre-heated to about 70 degree C., then flow through the Sonolator® for one pass as defined below.

| | | Orifice | Flow | Power | Energy | Avg. vesi- |
|---|---|---|---|---|---|---|
| | | size | rate | density | Density | cle dia- |
| | Pressure | (in\hat{ }2) | (kg/min) | (W/ml) | (J/ml) | meter (nm) |
| 2A | 1000 psi | 0.0005 | 1.79 | 20.6 | 6.89 | 164.7 |
| 2B | 2000 psi | 0.0005 | 2.53 | 58.2 | 13.78 | 144.9 |
| 2C | 3000 psi | 0.0005 | 3.11 | 107.0 | 20.67 | 146.5 |
| 2D | 5000 psi | 0.0005 | 4.01 | 230.2 | 34.45 | 137.4 |
| 2E | 5000 psi | 0.0005 | 4.01 | 230.2 | 34.45 | 132.0 |

“Quat” is a soft tallow BFA with the following chemical name: N,N-di(tallowoyloxyethyl)-N,N-dimethylammonium chloride. This FSA is available from Degussa under the trade name of Adogen SDMC and has an IV value of about 56.

Run #2E has perfume added to the melt esters of quaternary ammonium compounds (softness active) just before the Sonolator® process. The concentration of the perfume in the finished product is about 1.5%.

### C. Example 3

In another experiment with varying pressure, Quat (same as from Example 2) and acidic water are fed into an ultra-sonic homogenizer via a dual-feed for a single pass. No additional electrolyte is added in this sample. All samples produced nano-sized lamellar vesicles.

| | Concentration | Pressure | Orifice size | Viscosity @ |
|---|---|---|---|---|
| | of active % w/w | Psi | Square inches | low shear cps |
| 3A | 14 | 5000 | 0.0005 | 10 |
| 3B | 14 | 3000 | 0.0005 | 20 |
| 3C | 14 | 2000 | 0.0005 | 100 |
| 3D | 14 | 1000 | 0.0005 | 10000 |
| 3E | 14 | 1800 | 0.002 | 20000 |
| 3F | 10 | 1800 | 0.002 | 200 |
| 3G | 5 | 1800 | 0.002 | 8 |
| 3H | 14 | 1800 | 0.001 | 1000 |

### D. Example 4

A conventional fabric enhancing composition (having average vesicle diameter from between 200 nm to about 400 nm) is run fed into an ultra-sonic homogenizer with a Pressure of about 5000 Psi for 8 passes. Resultant average vesicle diameter is less than about 100 nm.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term in this written document conflicts with any meaning or definition in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric enhancer comprising: at least one cationic softening compound, wherein said cationic softening compound comprises a plurality of lamellar vesicles, said lamellar vesicles having an average diameter from about 10 nm to about 170 nm.

2. The fabric enhancer of claim 1, wherein said average diameter is from about 30 nm to about 150 nm.

3. The fabric enhancer of claim 1, wherein said cationic softening compound further comprises from about 1% to about 30% of said fabric enhancer, by weight of said fabric enhancer.

4. The fabric enhancer of claim 1, wherein said cationic softening compound comprises at least one quaternary ammonium compound.

5. The fabric enhancer of claim 4, wherein said quaternary ammonium compound comprises a mono-ester quaternary ammonium compound from about 0.1% to about 30%, by weight of said cationic softening compound.

6. The fabric enhancer of claim 5, wherein the quaternary ammonium compound comprises N,N-di(acyl-oxyethyl)-N,N-dimethylammonium chloride.

7. The fabric enhancer of claim 1, wherein cationic softening compound has an Iodine Value from about 1 to about 60.

8. The fabric enhancer of claim 1, further comprising from about 0.01% to about 5% of at least one cationic polymer, by weight of said fabric enhancer.

9. The fabric enhancer of claim 8, further comprising a lamellar vesicle volume fraction from about 0.01 to about 0.60.

10. The fabric enhancer of claim 8, further comprising substantially no phase separation as measured by the Shelf Storage Test and a viscosity below about 1000 centipoise.

11. A fabric enhancer comprising:
A. at least one cationic softening compound, wherein said cationic softening compound forms a plurality of lamellar vesicles comprising a radius of lamellar vesicles from about 5 nm to about 85 nm; and
B. at least one cationic polymer comprising a radius of gyration, wherein a ratio of said radius of lamellar vesicle to said radius of gyration of polymer is from about 40:1 to about 2:1.

12. A process of making a fabric enhancer comprising:
(a) providing a feed into a mixing chamber, said feed comprising:
(i) a cationic softening compound; and
(ii) a solvent;
(b) subjecting said feed within said mixing chamber to an energy density from about 1 J/ml to about 50 J/ml thereby producing a fabric enhancer according to claim 1; and
(c) discharging said fabric enhancer from said mixing chamber at a flow rate from about 1 kg/min to about 1000 kg/min.

13. The process of claim 12, wherein said step of subjecting said feed to said energy density comprises exerting a power density from about 0.5 W/ml to about 100,000 W/ml at a frequency from about 10 kHz to about 500 kHz.

14. The process of claim 12, wherein said step of providing said feed into said mixing chamber further comprises: passing said feed through an element forming an orifice comprising an orifice size from about 0.0005 inches² to about 0.1 inches².

15. The process of claim 12, wherein said feed passing through said mixing chamber creates a residence time of from about 1 millisecond to about 1 second.

16. The process of claim 12, wherein said step of providing said feed into said mixing chamber comprises: passing said feed through an element forming an orifice and comprising portions surrounding said orifice, wherein said portions has a hardness of greater than that of cemented tungsten carbide.

17. The process of claim 12, wherein said mixing chamber comprises a blade having a leading edge, wherein the leading edge of said blade has a hardness of greater than that of cemented tungsten carbide.

18. The process of claim 17, wherein the leading edge of said blade comprises: silicon nitride, titanium nitride, aluminum oxide, silicon carbide, titanium carbide, boron carbide, titanium diboride, boron oxide, rhenium diboride, cubic boron nitride, cubic BC2N, diamond-like carbon, diamond, composites of diamond and cubic boron nitride, and coatings of any of these materials, including diamond-coated materials and diamond-like carbon, and mixtures thereof.

19. The process of claim 12, wherein the process further comprises adding a perfume microcapsule to the discharged fabric enhancer.

20. The process of claim 12, wherein said feed further comprises a cationic polymer; a perfume; and mixtures thereof.
